(19) United States
(12) Patent Application Publication
(10) Pub. No.: US 2023/0390910 A1
(43) Pub. Date: Dec. 7, 2023

(54) Fastener removal tool and method of removing fasteners

(71) Applicant: Timothy Crawford, Golden, CO (US)

(72) Inventor: Timothy Crawford, Golden, CO (US)

(21) Appl. No.: 18/298,365

(22) Filed: Apr. 10, 2023

Related U.S. Application Data
(60) Provisional application No. 63/329,650, filed on Apr. 11, 2022.

(51) Int. Cl. B25C 11/00

(52) U.S. Cl. CPC B25C 11/00

(57) ABSTRACT

A fastener removal tool includes a handle; a cord movable between a first position and a second position relative to the handle; and an opening formed by the cord, wherein the opening has a first area when the cord is in the first position, wherein the opening has a second area when the cord is in the second position, wherein the first area is greater than the second area, wherein the opening is configured to extend around a head of a fastener when the cord is in the first position, and wherein the cord is configured to engage the head of the fastener proximate a shaft of the fastener when cord is in the second position. Other apparatus and methods are disclosed.

This application claims priority to U.S. provisional patent application 63/329,650 of Timothy Crawford, filed on Apr. 11, 2022, which is incorporated for reference for all that is disclosed therein.

### FIELD

Embodiments of the present disclosure relate to removal of fasteners, such as screws and nails, and methods of removing fasteners.

### BACKGROUND

Screws have threaded shafts that thread into threaded holes. If the threads on the shaft or in the hole become damaged, the screw is difficult to remove. For example, if a screw is being screwed into a material such as wood and the screw is tightened beyond the strength of the wood, the threads in the wood may strip. In such situations, the screw may spin freely in the hole. If the head of the screw is flush with the wood, removal of the screw without damaging the wood is difficult. In other situations, threads on the shaft of the screw may strip, which also makes removal of the screw difficult. Therefore, devices and methods that easily remove screws and other fasteners are sought.

### SUMMARY

According to a first aspect, a fastener removal tool is provided. The fastener removal tool includes a handle; a cord movable between a first position and a second position relative to the handle; and an opening formed by the cord, wherein the opening has a first area when the cord is in the first position, wherein the opening has a second area when the cord is in the second position, wherein the first area is greater than the second area, wherein the opening is configured to extend around a head of a fastener when the cord is in the first position, and wherein the cord is configured to engage the head of the fastener proximate a shaft of the fastener when cord is in the second position.

According to a second aspect, a screw removal tool is provided. The tool includes a handle; a cord movable relative to the handle, the cord having a first end and a second end, the first end coupled to a first point of the handle and the second end coupled to a second point of the handle; and a loop formable by the cord extending from the handle, the loop having a first length of cord extending from the handle when the tool is in a first condition and a second length of cord extending from the handle when the tool is in a second, wherein: the first length is greater than the second length, the cord is configured to pass under the head of screw when the tool is in the first condition, and the cord is configured to engage a shaft of a screw when the tool is in the second condition.

In another aspect, a method of removing a screw from a material is provided. The method includes providing a handle; providing a cord movable between a first position and a second position relative to the handle, wherein the cord has a curved portion extending from the handle; moving the cord to the first position, wherein the cord forms an opening having a first area when the cord is in the first position, the first area being greater than an area of a head of the screw; positioning the opening over the head of the screw so that the cord is proximate a shaft of the screw; moving the cord to the second position, wherein the opening has a second area when the cord is in the second position, the second area less than an area of a head of the screw; and lifting the screw from the material via at least the cord.

### BRIEF DESCRIPTION OF THE DRAWINGS

The drawings, described below, are provided for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a top isometric view of a screw removal tool with a cord forming an opening having a first area that enables the cord to pass over a head of a screw or fastener according to one or more embodiments.

FIG. 2 illustrates a top view of a screw removal tool with a cord forming an opening having a first area that enables the cord to pass over a head of a screw according to one or more embodiments.

FIG. 3 illustrates a top view of the screw removal tool of FIG. 2 with the cord forming an opening having second area that enables the cord to grasp a shaft of the screw proximate the head of the screw according to one or more embodiments.

FIG. 4 illustrates a side elevation view of a screw removal tool engaging a screw that is in a material according to one or more embodiments.

FIG. 5 illustrates a perspective sectional view of the tool of FIG. 1 according to one or more embodiments.

FIG. 6A illustrates a top plan view of a screw removal tool in an idle condition according to one or more embodiments.

FIG. 6B illustrates the screw removal tool of FIG. 6A in a first condition with a cord of the tool being in a first position where the cord is extending from an end of the tool to fit over a head of a screw according to one or more embodiments.

FIG. 6C illustrates the screw removal tool of FIG. 6A in a second condition with the cord of the tool being in a second position where the cord is located under a head of a screw according to one or more embodiments.

FIG. 7 illustrate a flowchart describing a method or removing a screw from a material according to one or more embodiments.

### DETAILED DESCRIPTION

Screws include a head and a threaded shaft wherein the threads of the screw are configured to engage similar threads in a hole. Rotation of the screw within the hole causes the screw to move into and out of the hole. If either the threads on the shaft or the threads of the hole strip or wear excessively, the screw may not move into or out of the hole when the screw is rotated. If the screw is fully inserted into a hole when the threads wear, the screw may be stuck in the hole. For example, that shaft threads may not engage the hole treads, so the screw in unable to move into or out of the hole by rotating the screw. Conventional screw removal tools and methods employed in such situations typically damage that material (e.g., wood) that the screw is screwed into.

In the case of wood and other soft materials, a user may use a self-tapping screw that forms threads into the wood as the screw is screwed (e.g., rotated) into the wood. The screw may be screwed into the wood to a point where the head of the screw is flush with a surface of the wood. If excessive force (e.g., torque) is applied to the screw when the head is flush with the surface of the wood, the threads formed in the wood may strip or wear, which may cause the screw to spin in the hole in the wood without engaging the threads. Rotating the screw in a direction to remove the screw from the hole may be ineffective because the threads cannot engage, and the screw is effectively stuck in the hole.

Conventional methods for removing stuck screws include forcing a screwdriver between the head of the screw and the material (e.g., wood) surface and prying the screw out of the hole while rotating the screw. For example, tools used to pry the screw out of the hole are forced between the wood and the screw head and damage the wood or other material.

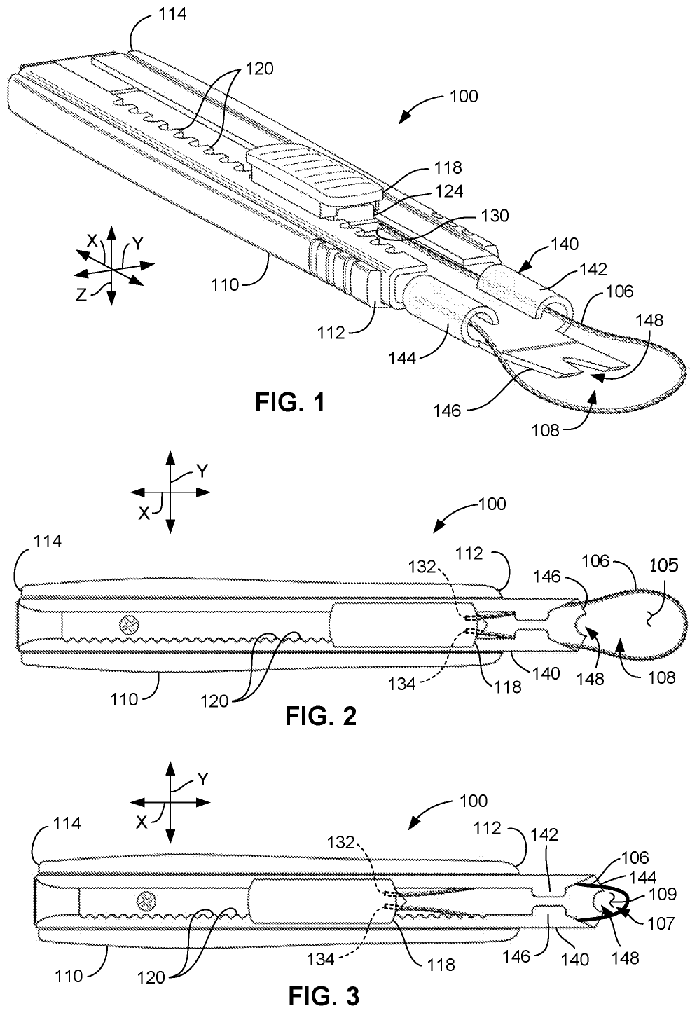

The tools and methods described herein provide easy removal of screws and other fasteners without damaging the materials in which the screws are screwed into. Embodiments of the tools and methods include a handle with a cord affixed to the handle. The cord forms an opening having a first area that enables the cord to be placed over the head of a screw that is stuck. After the cord is placed over the head of the screw, the cord is moved to a second position, which causes the area to have a second area that is smaller than the first area. The cord second area may be smaller than the area of the head of the screw. In the second position, the cord may contact the shaft and/or head of the screw. A force may be applied to tool to force the screw out of the hole. The handle may include a pry device having a notch configured to receive the shaft. The pry device enables the user to pry the screw out while the cord is engaged with the screw. These and other tools and methods are disclosed in greater detail with reference to FIGS. 1A-7.

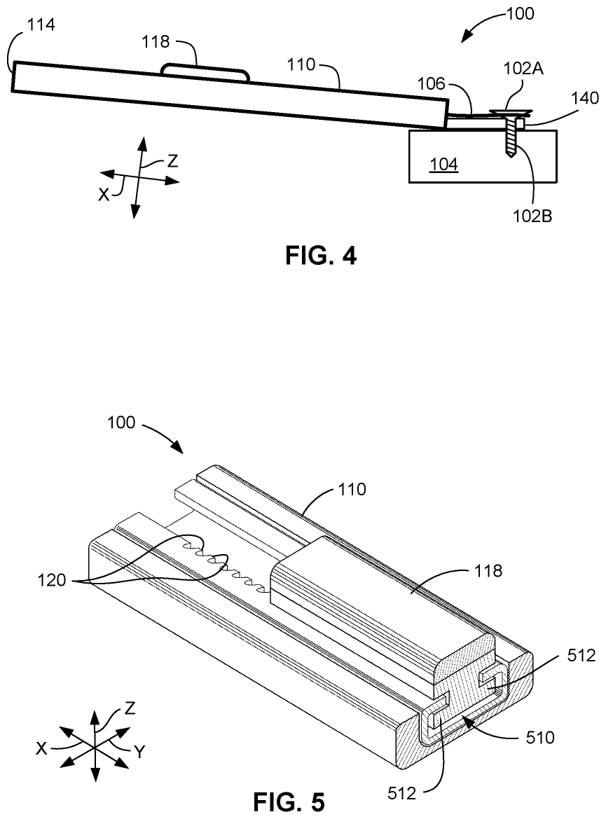

Reference is now made to FIGS. 1-3, which illustrate embodiments of a fastener removal tool 100 in different configurations. Reference is also made to FIG. 4, which illustrates a side elevation view of the fastener removal tool 100 engaging a screw 102. The fastener removal tool 100 is illustrated removing the screw 102 from a material 104. The fastener removal tool 100 may be used to remove other fasteners, such as nails and the like. FIG. 1 illustrates a side perspective view of a fastener removal tool 100, FIG. 2 illustrates a top plan view of the tool 100 with a cord 106 forming an opening 107 having a first area 108, and FIG. 3 illustrates a top plan view of the tool 100 with the cord 106 forming the opening 107 having a second area 109, wherein the first area 108 is greater than the second area 109. When the cord 106 forms the first area 108, the cord 106 is referred to as being in a first position and is configured to pass over a head 102A of the screw 102. Thus, the first area 108 may be greater than the area of the head of the screw. When the cord 106 forms the second area 109, which is smaller than the first area 108, the cord 106 is configured to wrap around at least a portion of a shaft 1028 of the screw 102 or other fastener (e.g., a nail) to enable a user to use the tool 100 to remove the screw 102 from the material 104 in which the screw 102 is stuck.

The tool 100 may include a handle 110 to which the cord 106 is affixed. The handle 110 has a first end 112 and a second end 114 opposite the first end 112, wherein the cord 106 is proximate the first end 112. In some embodiments, the handle 110 includes a slide 118 to which the cord 106 is affixed. In other embodiments, the cord 106 may be a continuous band wherein a portion of the continuous band may be affixed to the handle 110 or the slide 118. The slide 118 may be coupled to the handle 110 in such a manner as to enable the slide 118 to move relative to the handle 110, but not become separated from the handle 110 during normal operation of the tool 100. The slide 118 may move along an x-axis extending generally between the first end 112 and the second end 114.

The slide 118 may include a retaining mechanism 130 that temporarily maintains the slide 118 in a fixed position relative to the handle 110. The retaining mechanism 130 may prevent the cord 106 or the slide 118 from transitioning between different positions or conditions unless an action is performed by a user of the tool 100. Maintaining the slide 118 in a fixed position means that the more force is required to move the slide 118 when the slide 118 is maintained in the fixed position relative to when the slide 118 is not maintained in the fixed position. In some embodiments, the slide 118 may include or be coupled to a detent mechanism that maintains the slide 118 in a fixed position relative to handle 110 until the detent mechanism is disengaged. In the embodiments described herein, the handle 110 may include a plurality of teeth 120 (a few labelled) that are fixed relative to the handle 110.

The slide 118 described herein may include a pin 124 that is configured to temporarily engage the teeth 120. The pin 124 may be configured to have a force applied thereto wherein the force causes the pin 124 to engage the teeth 120, which retains the slide 118 and thus, the cord, in a fixed location. In this fixed location, the cord 106 may be prevented from moving relative to the handle 110. The fixed position of the slide 118 prevents the cord 106 extending from the handle 110 to change. When a force, such as a force applied downward in the z-direction, is applied to the slide 118, the pin 124 may disengage from the teeth 120, which enables the slide to move relative to the handle 110. The movement enables the length of the cord 106 extending from the handle 110 to change, which enables the area of the opening 107 to change. The change in the cord 106 may be referred to as moving between a first position and a second position.

In some embodiments, the cord 106 is not continuous and has a first end 132 and a second end 134. One or both of the first end 132 or the second end 134 may be affixed to the handle 110. In some embodiments, the first end 132 or the second end 134 may be affixed to the slide 118 and the other end may be affixed to a fixed location of the handle 110. In yet other embodiments, both the first end 132 and the second end 134 may be affixed to the slide 118. By affixing both the first end 132 and the second end 134 to the slide 118, the area formed by the opening 107 changes faster with movement of the slide 118 than if only one of the ends is affixed to the slide 118. In embodiments wherein the cord 108 is continuous, a portion of the cord 106 may be affixed to the slide 118 in a similar manner.

The handle 110 may include a guide 140 configured to keep the cord 106 from folding or moving too far from the handle 110 while enabling the cord 106 to move between the first position and the second position. For example, the guide 140 may keep the cord 106 in a predetermined position in the z-axis at the first end 112 of the handle 110 when the tool 100 is in use. Thus, the guide 140 may maintain the cord 106 in a predetermined position as the cord 106 is either or both wrapping around a screw or removing a screw as described herein. For example, the cord 106 may not bend, warp, or twist beyond a predetermined amount. The guide 140 may be fixed to the handle 110 such that the slide 118 may be movable (e.g., slidable) relative to the guide 140. The guide 140 may include a first retainer 142 and a second retainer 144 that further maintain the cord 106 in the predetermined position. At least one of the first retainer 142 and the second retainer 144 may be loops or partial loops wherein the cord 106 is received in the loops. In other embodiments, the first retainer 142 and/or the second retainer 144 may be grooves.

The tool 100 may include a pry device 146 extending from the first end 112 of the handle 110. The pry device 146 may be configured to apply a force to the head 102A of the screw 102 to lift the screw 102 in the slightly out of the material 104 so the cord 106 may be placed over the head 102A of the screw 102 to engage the shaft 102B of the screw 102. The pry device 146 may be made of a rigid material that can pry the screw 102 slightly from the material 104 in which the screw 102 is located without damaging the material 104. In some embodiments, the pry device 146 may include a notch 148 configured to receive the shaft 102B of the screw 102. For example, the pry device 146 may be placed between the material 104 and the head 102A of the screw 102 and the notch 148 may receive the shaft 102B of the screw 102. By applying a force to the handle 110 in the z-direction, the screw 102 may be slightly lifted from the material 104.

Additional reference is made to FIG. 5, which is a top perspective sectional view of the tool 100. As shown in FIG. 5, the handle 110 may include a channel 510 and the slide 118 may include extension members 512 that are received in the channel 510 and enable the slide 118 to move in the x-direction relative to the handle 110. The combination of the extension members 512 and the channel 510 also prevent the slide 118 from separating from the handle 110 during operation of the tool 100. For example, the combination of the extension members 512 and the channel 510 prevent the slide 118 from moving in the z-direction and separating from the handle 110. The combination of the extension members 512 and the channel 510 also may enable the slide 118 to be depressed toward the handle 110 to release the slide 118 from the teeth 120 and enable the slide 118 to move freely in the x-direction.

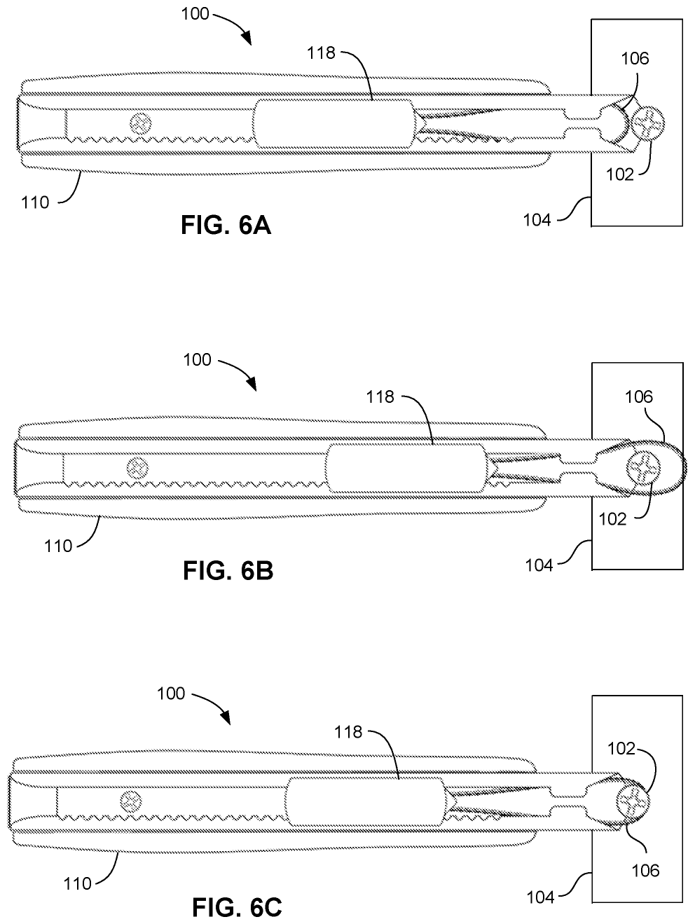

Additional reference is made to FIGS. 6A-6C, which illustrate the tool 100 removing the screw 102 from the material 104. The screw 102 may be a machine screw, a wood screw, a drywall screw, or other types of screws. As described above, the tool 100 may also remove fasteners such as nails from materials the in the same or similar manners as described relative to the screw 102. The material 104 may be wood, metal, drywall, or other materials. FIG. 6A illustrates the tool 100 in an idle condition. In the idle condition, the cord 106 may be substantially in the handle 110 so that that cord 106 does not become entangled on objects other than the screw 102. The pry device 146 may be placed under the head 102A of the screw 102, such as between the material 104 and the screw 102. The notch 148 may be receive the shaft 102B of the screw 102 to maintain the pry device 146 in a fixed location relative to the shaft 102B of the screw 102.

FIG. 6B illustrates the tool 100 is a first condition wherein the cord 106 is in the first position extended from the first end 112 of the handle 110. In some embodiments, the slide 118 may be depressed in the z-direction and then slid toward the first end 112 of the handle 110 to extend the cord 106 as shown in FIG. 6B. The first condition may be defined as the opening 107 provided by the cord 106 having the first area 108, which is larger than the second area 109. The first condition or position may be defined as the length of the cord 106 extending from the first end 112 being longer than the length of the cord 106 extending from the first end 112 when the tool 100 is in the second condition as shown in FIG. 6C. When the tool 100 is in the first condition, the length of cord 106 extending from the first end 112 may be long enough to extend over the head 102A of the screw 102 as shown in FIG. 6B. The first area 108 may also be greater than the area of the head 102A of the screw 102.

FIG. 6C illustrates the tool 100 is a second condition or position wherein the cord has engaged the screw 102 below the head 102A. In some embodiments, the slide 118 may be depressed in the z-direction and then slid away from the first end 112 of the handle 110 to pull the cord 106 under the head 102A of the screw 102 as shown in FIG. 6C. The second condition or position may be defined as the opening 107 of the cord 106 having the second area 109, which is smaller than the first area 108. The second condition may be defined as the length of the cord 106 extending from the first end 112 being shorter than the length of the cord 106 extending from the first end 112 when the tool 100 is in the first condition as shown in FIG. 6B.

With the tool 100 in the second condition, the screw 102 may be removed from the material 104. In some embodiments, the handle 110 may be depressed against the material 104 so that the pry device 146 pries the screw 102 from the material 104. In some embodiments, the screw 102 may be rotated as the tool 100 forces the screw 102 from the material 104. The force in combination with the rotation of the screw 102 may cause threads (or remnants of threads) on the screw 102 to engage threads (or remnants of threads) in the material 104. The screw 102 is then readily removed from the material 104 with no or minimal damage to the material 104.

The tool 100 has been described herein as being configured to remove screws from materials, such as wood and drywall. The tool 100 may also remove nails and similar nonthreaded fasteners from wood and other materials. For example, the tool 100 may be used as described above to remove a nail instead of the screw 102.

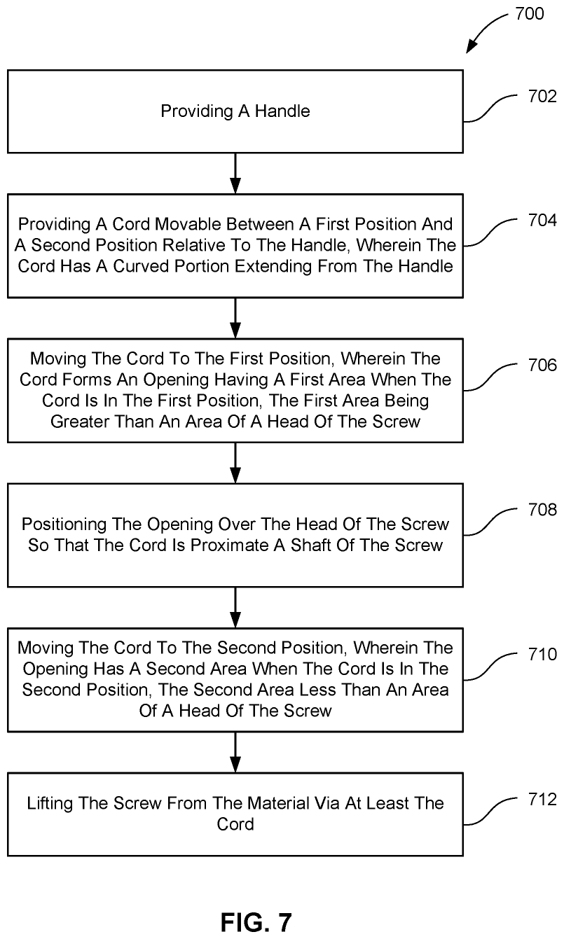

Additional reference is made to FIG. 7 which illustrates a flowchart describing a method 700 of removing a screw (e.g., screw 102) from a material (e.g., material 104). The method 700 includes, in block 702, providing a handle (e.g., handle 110). The method 700 includes, in block 704, providing a cord (e.g., cord 106) movable between a first position and a second position relative to the handle, wherein the cord has a curved portion extending from the handle. The method 700 includes, in block 706, moving the cord to the first position, wherein the cord forms an opening (e.g., opening 107) having a first area (e.g., first area 108) when the cord is in the first position, the first area being greater than an area of a head (e.g., head 1028) of the screw. The method 700 includes, in block 708, positioning the opening over the head of the screw so that the cord is proximate a shaft (e.g., shaft 102B) of the screw. The method 700 includes, in block 710, moving the cord to the second position, wherein the opening has a second area (e.g., second area 109) when the cord is in the second position, the second area less than an area of a head of the screw. The method 700 includes, in block 712, lifting the screw from the material via at least the cord.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

What is claimed is:

1. A fastener removal tool comprising:
a handle;
a cord movable between a first position and a second position relative to the handle; and
an opening formed by the cord, wherein the opening has a first area when the cord is in the first position, wherein the opening has a second area when the cord is in the second position, wherein the first area is greater than the second area, wherein the opening is configured to extend around a head of a fastener when the cord is in the first position, and wherein the cord is configured to engage the head of the fastener proximate a shaft of the fastener when cord is in the second position.

2. The fastener removal tool of claim 1, further comprising a slide slidably coupled to the handle, wherein at least a portion of the cord is coupled to the slide.

3. The fastener removal tool of claim 2, further comprising a retaining mechanism located between the handle and the slide, the retaining mechanism configured to maintain the slide in at least one fixed location relative to the handle.

4. The fastener removal tool of claim 3, wherein the cord is maintained in the first position in response to the slide being in a first position and wherein the cord is maintained in the second position in response to the slide being in a second position.

5. The fastener removal tool of claim 2, wherein movement of the slide relative to the handle causes the cord to transition between the first position and the second position.

6. The fastener removal tool of claim 1, further comprising a pry device extending from the handle, wherein the pry device is configured to be positioned between the head of the fastener and a material in which the fastener is located.

7. The fastener removal tool of claim 6, wherein the pry device comprises a notch, wherein the cord at least partially encircles the notch, and wherein the notch is configured to receive the shaft of the fastener.

8. The fastener removal tool of claim 1, further comprising at least one retainer configured to receive the cord and enable the cord to move between the first position and the second position.

9. The fastener removal tool of claim 1, wherein the cord is a continuous band.

10. The fastener removal tool of claim 1, wherein the fastener is a screw.

11. A screw removal tool comprising:
a handle;
a cord movable relative to the handle, the cord having a first end and a second end, the first end coupled to a first point of the handle and the second end coupled to a second point of the handle; and
a loop formable by the cord extending from the handle, the loop having a first length of cord extending from the handle when the tool is in a first condition and a second length of cord extending from the handle when the tool is in a second, wherein:
the first length is greater than the second length,
the cord is configured to pass under the head of screw when the tool is in the first condition, and
the cord is configured to engage a shaft of a screw when the tool is in the second condition.

12. The screw removal tool of claim 10, further comprising a slide slidably coupled to the handle, wherein at least a portion of the cord is coupled to the slide.

13. The screw removal tool of claim 12, further comprising a retaining mechanism located between the handle and the slide, the retaining mechanism configured to maintain the slide in at least one fixed location relative to the handle.

14. The screw removal tool of claim 13, wherein the cord is maintained in the first position in response to the slide being in a first position and wherein the cord is maintained in the second position in response to the slide being in a second position.

15. The screw removal tool of claim 12, wherein movement of the slide relative to the handle causes the cord to transition between the first position and the second position.

16. The screw removal tool of claim 11, further comprising a pry device extending from the handle, wherein the pry device is configured to be positioned between the head of the screw and a material in which the screw is located.

17. The screw removal tool of claim 16, wherein the pry device comprises a notch, wherein the cord at least partially encircles the notch, and wherein the notch is configured to receive the shaft of the screw.

18. The screw removal tool of claim 1, further comprising at least one retainer configured to receive the cord and enable the cord to move between the first position and the second position.

19. The screw removal tool of claim 11, wherein the cord is a continuous band.

20. A method of removing a screw from a material, the method comprising:
providing a handle;
providing a cord movable between a first position and a second position relative to the handle, wherein the cord has a curved portion extending from the handle;
moving the cord to the first position, wherein the cord forms an opening having a first area when the cord is in the first position, the first area being greater than an area of a head of the screw;
positioning the opening over the head of the screw so that the cord is proximate a shaft of the screw;
moving the cord to the second position, wherein the opening has a second area when the cord is in the second position, the second area less than an area of a head of the screw; and
lifting the screw from the material via at least the cord.
